(19) United States
(12) Patent Application Publication
(10) Pub. No.: US 2019/0017294 A1
(43) Pub. Date: Jan. 17, 2019

(54) LOCKING DEVICE WITH TRACKING FUNCTIONALITY

(71) Applicant: Cabeau, Inc., Woodland Hills, CA (US)

(72) Inventors: David Bret Sternlight, Woodland Hills, CA (US); Kevin Dixon, Playa Vista, CA (US); John Wilkening, Capitola, CA (US); Troy Osmond Christiansen, St. George, UT (US); Joshua Seth Mark Cross, Magna, UT (US)

(73) Assignee: Cabeau, Inc., Woodland Hills, CA (US)

(21) Appl. No.: 16/036,500

(22) Filed: Jul. 16, 2018

Related U.S. Application Data
(60) Provisional application No. 62/532,881, filed on Jul. 14, 2017.

(51) Int. Cl. E05B 73/00; G07C 9/00; E05B 35/10; E05B 39/00; E05B 47/00

(52) U.S. Cl. CPC E05B 73/0005; G07C 9/00309; H04W 4/02; E05B 39/005; E05B 47/00; E05B 35/105

(57) ABSTRACT

Disclosed herein are locking devices having tracking functionality. In some embodiments, the locking devices may include a connector arm configured to engage with and secure an object to the locking device, and a housing. The housing may include a locking module comprising a locking mechanism configured to releasably secure and engage the connector arm with the locking device, and a plurality of unlocking mechanisms configured to release and disengage the connector arm from the locking device. The housing may also include a tracking module configured to determine the location of the locking device, a search alert module configured to provide a search alert notification to a user of the locking device responsive to the use of at least one of the plurality of unlocking mechanisms, a distress module configured to provide a distress notification to a designated contact of the user of the locking device, a tamper module configured to determine unauthorized access to at least one of the connector arm and the housing, and a communications module configured to receive and transmit signals for operating one or more of the locking module, the tracking module, search alert module, distress module, and tamper module.

### CROSS-REFERENCE TO RELATED APPLICATIONS

The present disclosure claims priority to U.S. Provisional Application No. 62/532,881 filed on Jul. 14, 2017, the contents of which are hereby incorporated by reference.

### TECHNICAL FIELD

The present disclosure relates to locking devices having tracking functionality.

### BACKGROUND

Locking devices may be used in shipping, travel, commuting, tracking, recreational uses and the like. For example, locking devices are attached to luggage and widely used to prevent unwanted access to travelers' items. However, conventional locking devices suffer from common drawbacks such as being bulky. They may also be limited based on the method of tracking functionality utilized, if any. Conventional locking devices have been insufficient to deter thieves, including airport employees, from unlawfully taking travelers' personal property from their luggage.

For example, some conventional locking devices may indicate when a key has been used to unlock it, but offer no tracking functionality, and thus provide no opportunity for the recovery of stolen luggage. Additionally, conventional locking systems may contain an integral camera, but may not provide means for communicating information with the user of the lock. Additionally, conventional locking systems may have limited communication and tracking capabilities (i.e., they may be limited to outdoor use) due to the limitations of Global Positioning System (GPS) technology. Other locking systems may offer tracking and communication, but may not be transferrable between luggage articles and fail to inform the user when the article is unlocked by airport employees.

### SUMMARY OF THE DISCLOSURE

The present disclosure is generally directed to locks that can include tracking functionality. Examples include luggage locks.

In some embodiments, a locking device includes a connector arm and housing. A connector arm may be configured to engage with and secure an object to the locking device. The housing may include a locking module having a locking mechanism configured to releasably secure and engage the connector arm with the housing, and a plurality of unlocking mechanisms configured to release and disengage the connector arm from the housing, a communications module configured to receive and transmit signals for operating one or more of the locking module, a tracking module, a search alert module, a distress module, and a tamper module, a tracking module configured to determine the location of the locking device based on one or more signals transmitted and received from the communications module, the search alert module configured to provide a search alert notification to a user of the locking device responsive to the use of at least one of the plurality of unlocking mechanisms of the locking module, the distress module configured to provide a distress notification to a designated contact of the user of the locking device via the communications module, and a tamper module configured to determine whether at least one of the connector arm and the housing was accessed without engaging one of the plurality of unlocking mechanisms of the locking module and provide, via the communications module, a tamper notification to the user of the locking device responsive to determining that at least one of the connector arm and the housing was accessed without engaging one of the plurality of unlocking mechanisms.

In some embodiments, a primary unlocking mechanism from among the plurality of unlocking mechanisms is configured to receive electromechanical input from the user of the locking device by input at the housing of the locking device. The electromechanical input includes performance of a predetermined unlocking sequence on one or more buttons located on an exterior of the housing that are operable for releasing and disengaging the connector arm from the housing. A secondary unlocking mechanism from among the plurality of unlocking mechanisms is configured to receive a standardized mechanical key. Additionally, use of the secondary unlocking mechanism initiates the search alert module to provide a notification to the user of the locking device. A tertiary unlocking mechanism from among the plurality of unlocking mechanisms includes a wireless signal configured for releasing and disengaging the connector arm from the housing.

In some embodiments, the communications module is configured for operation using at least one of a Bluetooth®, Narrowband, GSM, LTE, Wi-Fi®, and Near Field communication protocols. The communication module may be configured to prioritize communication using Bluetooth® and Near Field communication protocols over at least one of the Narrowband, GSM, LTE, and Wi-Fi® communication protocols. The communication module may be configured to prioritize communication using Narrowband communication protocols over at least one of GSM, LTE, and Wi-Fi® communication protocols. The housing comprises at least one of a gyroscope, accelerometer, and altimeter. The distress notification is generated responsive to performance of a predetermined sequence on one or more distress buttons located on an exterior of the housing. The housing comprises a non-transitory memory configured to store data produced by at least one of the locking module, the search alert module, the tracking module, the communications module, the distress module, and the tamper module.

In some embodiments, a system includes a locking device, a user computing device, and a server system. In some embodiments, the locking device may include a locking module having a locking mechanism configured to releasably engage with and secure the locking device to an object, and a plurality of unlocking mechanisms configured to release and disengage the object from the locking device. The locking device may also include a communications module configured to receive and transmit signals for operating one or more of the locking module, a tracking module, a search alert module, a distress module, and a tamper module, the tracking module configured to determine the location of the locking device based on one or more signals transmitted and received from the communications module, the search alert module configured to provide a search alert notification to a user of the locking device responsive to the use of at least one of the plurality of unlocking mechanisms of the locking module, the distress module configured to provide a distress notification to a designated contact of the user of the locking device via the communications module, and a tamper module configured to determine whether the locking device was accessed without engaging one of the plurality of unlocking mechanisms of the locking module and provide, via the communications module, a tamper notification to the user of the locking device responsive to determining that the locking device was accessed without engaging one of the plurality of unlocking mechanisms. The user computing device may be communicatively coupled to the locking device and a server system, and include a user interface configured to display data and information related to the locking device received from the locking device and the server system. The server system may be configured to generate one or more graphics configured for display on the user interface based on operation of the locking device. The operation of the locking device may be based on user preferences and settings provided by at least one of the server system and the user computing device via the user interface.

In some embodiments, the user interface displays tracking data provided by the tracking module of the locking device. In some embodiments the user interface displays at least one of the distress notification and a search alert notification. In some embodiments, the tamper module is configured to generate a tamper notification when it determines that there was unauthorized access to the locking device and the tamper notification is communicated to the user interface for display. In some embodiments, a primary unlocking mechanism from among the plurality of unlocking mechanisms is configured to receive electromechanical input from a user of the locking device by input at a housing of the locking device, a secondary unlocking mechanism from among the plurality of unlocking mechanisms is configured to receive a standardized mechanical key, and a tertiary unlocking mechanism from among the plurality of unlocking mechanisms includes a wireless signal configured for releasing and disengaging the object from the locking device. In some embodiments, the communications module further comprises a tiered protocol where the communications module is configured for operation using at least one of a Bluetooth®, Narrowband, GSM, LTE, Wi-Fi®, and Near Field communication protocols, configured to prioritize communication using Bluetooth® and Near Field communication protocols over at least one of the Narrowband, GSM, LTE, and Wi-Fi® communication protocol, and further configured to prioritize communication using Narrowband communication protocols over at least one of GSM, LTE, and Wi-Fi® communication protocols. In some embodiments, the server system is communicatively coupled to a database configured to store at least one of firmware, user preferences, and locking device information, wherein locking device information further comprises an association between user computing devices and locking devices. In some embodiments, the designated contact of the user of the locking device is provided by the user to the locking device via the user interface.

### BRIEF DESCRIPTION OF THE DRAWINGS

These and other further features and advantages of the disclosure would be apparent to those skilled in the art from the following detailed description, taken together with the accompanying drawings, in which:

FIG. 1 is a system diagram for a system including a locking device according to an aspect of the present disclosure.

FIG. 2A is a front perspective view of an embodiment of a locking device according to an aspect of the present disclosure.

FIG. 2B is a rear perspective view of an embodiment of a locking device according to an aspect of the present disclosure.

FIG. 2C is a top view of an embodiment of a locking device according to an aspect of the present disclosure.

FIG. 2D is a bottom view of an embodiment of a locking device according to an aspect of the present disclosure.

FIG. 2E is a first side view of an embodiment of a locking device according to an aspect of the present disclosure.

FIG. 2F is a second side view of an embodiment of a locking device according to an aspect of the present disclosure.

FIG. 2G is a third side view of an embodiment of a locking device according to an aspect of the present disclosure.

FIG. 2H is a bottom view of an embodiment of a locking device according to an aspect of the present disclosure.

FIG. 2I is a top perspective view of an embodiment of a locking device according to an aspect of the present disclosure.

FIG. 2J is a first side view of an embodiment of a locking device according to an aspect of the present disclosure.

FIG. 2K is a second side view of an embodiment of a locking device according to an aspect of the present disclosure.

FIG. 2L is a third side view of an embodiment of a locking device according to an aspect of the present disclosure.

FIG. 3 is a perspective view of an embodiment of a locking device according to an aspect of the present disclosure.

FIG. 4A is a front elevational view of one embodiment of a locking device according to the present disclosure.

FIG. 4B is a front elevational view of the locking device shown in FIG. 4A, with the case shown as partially transparent for viewing.

FIG. 4C is a rear elevational view of the locking device shown in FIGS. 4A and 4B, with the case shown as partially transparent for viewing.

FIG. 5 is a front elevational view of another embodiment of a locking device according to the present disclosure.

FIG. 6A illustrates a first screen associated with a mobile application in accordance with an embodiment of the present disclosure.

FIG. 6B illustrates a first screen associated with a mobile application in accordance with an embodiment of the present disclosure.

FIG. 6C illustrates a first screen associated with a mobile application in accordance with an embodiment of the present disclosure.

FIG. 6D illustrates a first screen associated with a mobile application in accordance with an embodiment of the present disclosure.

FIG. 6E illustrates a first screen associated with a mobile application in accordance with an embodiment of the present disclosure.

FIG. 6F illustrates a first screen associated with a mobile application in accordance with an embodiment of the present disclosure.

FIG. 6G illustrates a first screen associated with a mobile application in accordance with an embodiment of the present disclosure.

FIG. 6H illustrates a first screen associated with a mobile application in accordance with an embodiment of the present disclosure.

FIG. 6I illustrates a first screen associated with a mobile application in accordance with an embodiment of the present disclosure.

FIG. 7 illustrates a computing system in accordance with an embodiment of the present disclosure.

### DETAILED DESCRIPTION

The present disclosure is directed towards locking devices having tracking functionality, and more particularly to luggage locks with tracking functionality.

The present disclosure describes locking devices with tracking and communication capabilities utilizing one or more of the Global Positioning System (“GPS”), the Global System for Mobile Communications (“GSM”), Wi-Fi®, Bluetooth®, Narrowband Communications (NB), and the like. Different embodiments of locks according to embodiments of the present disclosure may increase the security of objects bearing the locks, and enabling the tracking of the locking device, and thus any objects (e.g., individuals, luggage) to which the locking device may be attached. Additional capabilities of the disclosed locking devices include notification and alerting capabilities in the event of a distressing incident and/or tampering of the locking device.

In some embodiments, the locking device may include a plurality of unlocking mechanisms that are configured to operate independently of each other. The locking device may also include one or more of tracking modules, sensors, search alert modules, communication modules, distress modules, and tamper modules. The locking device may be configured to provide alerts or notifications to user via a user computing device (e.g., mobile phone, laptop, tablet).

The present disclosure is described herein with reference to certain embodiments, but it is understood that the disclosure may be embodied in many different forms and should not be construed as limited to the embodiments set forth herein. The devices and elements herein may have different shapes and sizes beyond those shown. It is also understood that when a feature or element, such as a layer, region, case, cover, frame, or otherwise may be referred to as being “on” another element, it can be directly on the other element or intervening elements may also be present. Furthermore, relative terms such as “inner,” “outer,” “upper,” “above,” “lower,” “beneath,” and “below,” and similar terms, may be used herein to describe a relationship of one element to another. It is understood that these terms are intended to encompass different orientations of the device in addition to the orientation depicted in the figures.

Although the terms first, second, etc. may be used herein to describe various elements, components, regions, layers and/or sections, these elements, components, regions, layers and/or sections should not be limited by these terms. These terms are only used to distinguish one element, component, region, layer, or section from another region, layer, or section. Thus, a first element, component, region, layer, or section discussed below could be termed a second element, component, region, layer, or section without departing from the teachings of the present disclosure.

Unless the context clearly requires otherwise, throughout the description and the claims, the words “comprise,” “comprising,” “include,” “including,” and the like are to be construed in an inclusive sense as opposed to an exclusive or exhaustive sense; that is to say, in the sense of “including, but not limited to.” Words using the singular or plural number also include the plural or singular number respectively. When the word “each” is used to refer to an element, it does not necessarily imply a plurality of the elements, but can also mean a singular element.

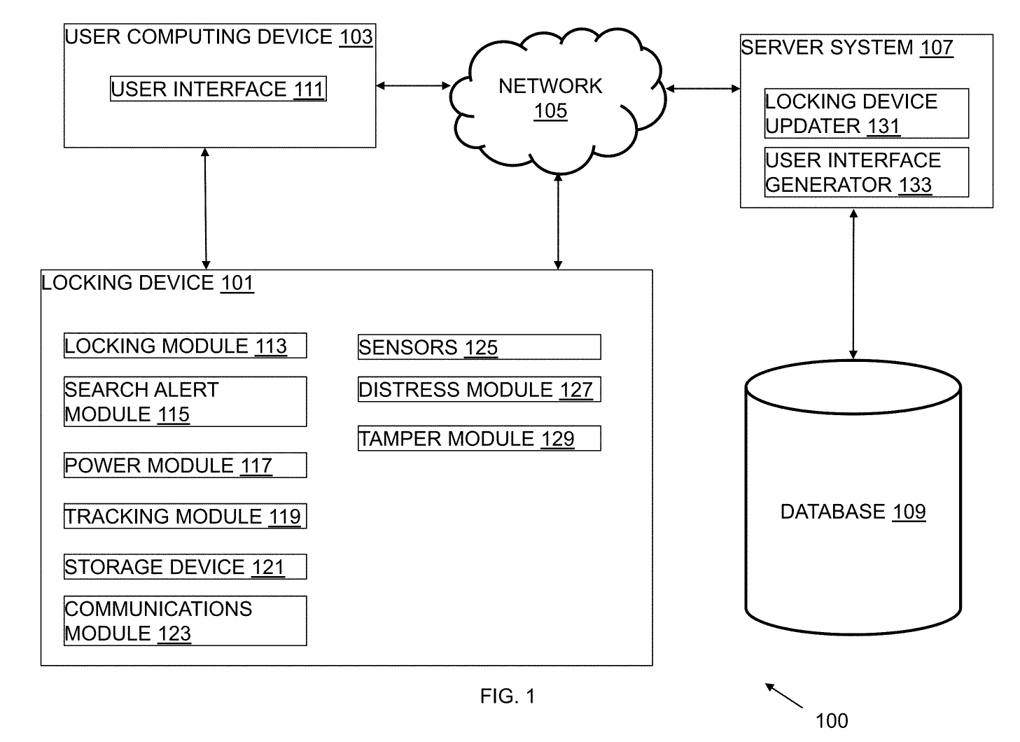

FIG. 1 is a system diagram for a system 100 including one or more locking devices 101. As illustrated in FIG. 1, the locking devices 101 may be communicatively coupled to a user computing device 103 such as a mobile smart phone, tablet, laptop, and the like. In some embodiments, the direct coupling between the user computing device 103 and the locking device 101 may utilize a Bluetooth® or Near-field communication (NFC) connection, and the like. The user computer device 103 may include a user interface 111 configured to communicate with the locking device 101. The locking device 101 may also be in communication with a server system 107 via a network 105. If a direct communication link between the user computing device 103 and the locking device 101 via Bluetooth® or NFC is unavailable, the user computing device 103 and the locking device 101 may also communicate via the network 105. The server system 107 may be configured to be in communication with a plurality of locking devices 101 each of which are coupled to one or more user computing devices 103. Additionally, the user computing devices 103 may be communicatively coupled to the server system 107 via the network 105. Although a single user computing device 103 and locking device 101 are depicted in FIG. 1, it is understood that a system 100 may include a plurality of user computing devices 103 and locking devices 101.

The network 105 may include, or operate in conjunction with, an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks.

The server system 107 may be configured to include a locking device updater 131 configured to receive and update data from the locking device and a user interface generator module 133 configured to generate components of the user interface 133.

The server system 107 may be coupled to a database 109 configured to store firmware, user preferences, locking device information and the like. The database 109 may be configured to store locking device and user computing device information. For example, serial numbers for locking devices may be stored in accordance with their associated user phone number or SIM card information. User preferences may include user name, addresses, contacts, billing information, cellular network information, cellular network carrier data, and the like. Data stored in database 109 may be encrypted.

In some embodiments, the server system, and/or database 109 may be configured on a webserver, cloud storage system and the like.

The locking device 101 may include one or modules having electromechanical and/or software components. Components of the locking device 101 may include one or more of a locking module 113, a search alert module 115, a power module 117, a tracking module 119, a storage device 121, a communications module 123, sensors 125, a distress module 127, and a tamper module 129. The locking device 101 may also include a microcontroller, central processing unit, integrated charging circuits, thermistors, light emitting diode (LED) indicators and/or connectors.

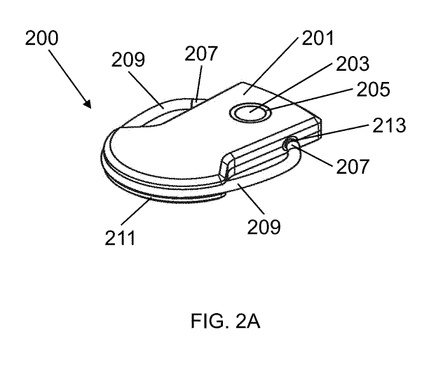

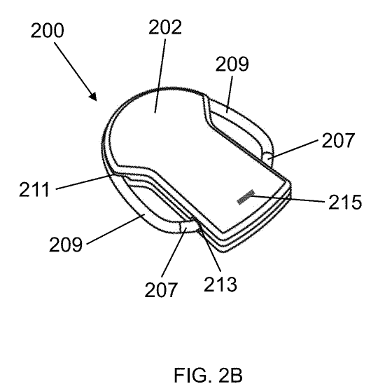

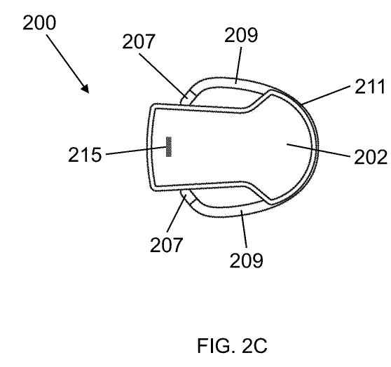

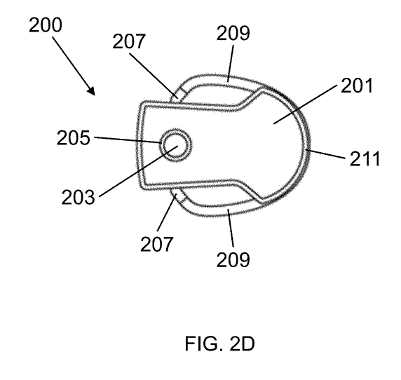

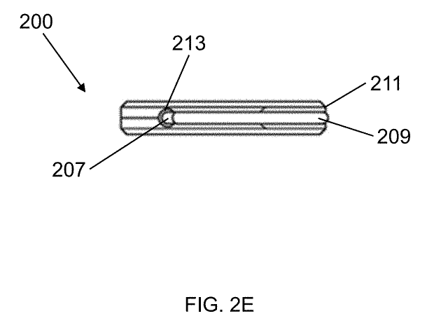

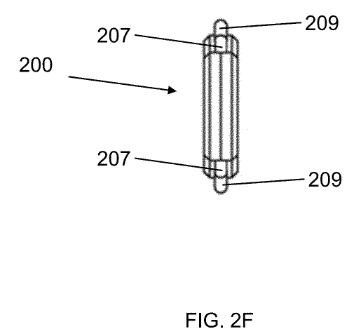

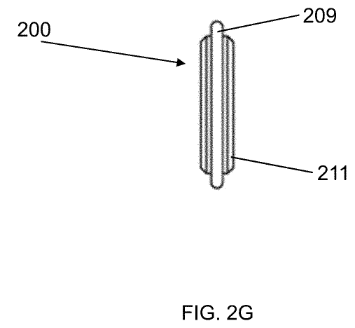

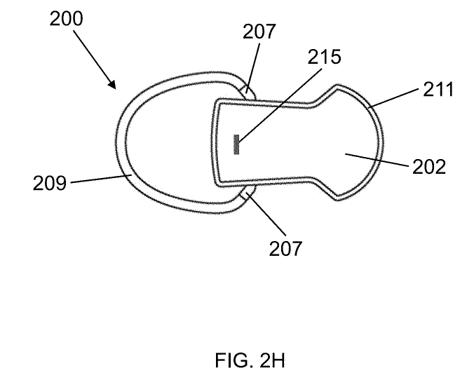

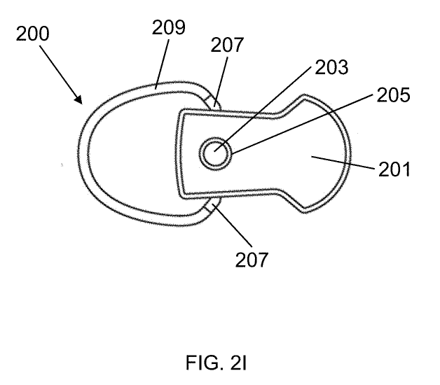

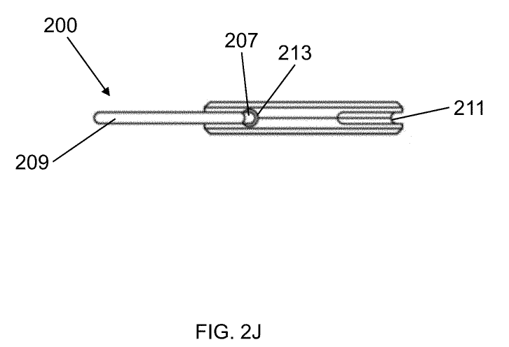

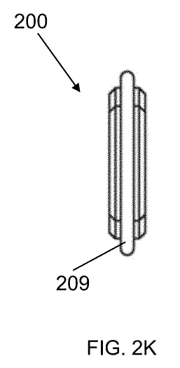

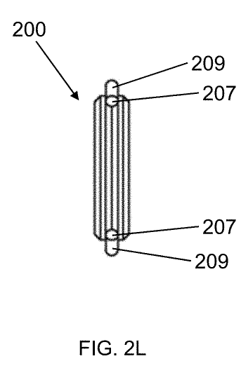

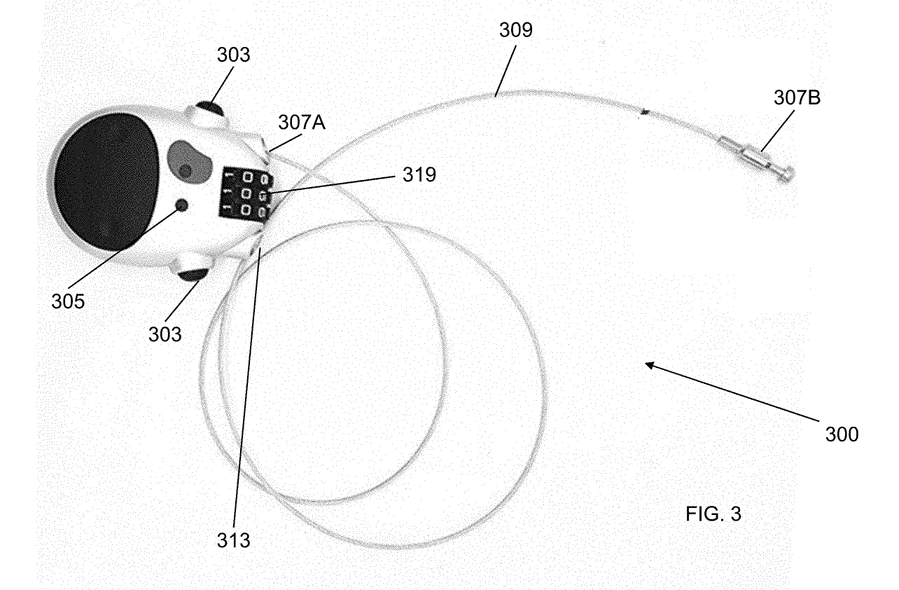

The locking device 101 may include a locking module 113 configured to reversibly engage and secure an object to the locking device 101. In particular, the locking device 101 may include a housing or case and one or more connector arms (as further described in relation to FIGS. 2A-3). Each of the one or more connector arms may be configured for reversible and secure engagement with the housing or case of the locking device 101. The connectors arms may be further configured to engage with and secure one or more objects to the locking device 101. The locking module 113 may include an electrical, mechanical, and/or electromechanical mechanism configured to securely engage (and disengage) a connector arm with an engagement point located on the locking device. In some embodiments, the engagement points may be located along the exterior of the housing of the locking device.

In some embodiments, to engage or lock the locking device 101, an end portion of a connecting arm (such as the connector arms depicted in FIGS. 2-3) may slide into and engage with an engagement point located on the housing of the locking device 101. When in the locked position, the connecting arm connects the locking mechanism to the engagement point. In one embodiment, when in the unlocked position, the connecting arm can slide vertically into or out of, and/or rotate in, the engagement point. The connecting arm may be removable from the engagement point. The connecting arm may be a metal, composite, plastic, or other materials. For example, the connecting device may be a coiled wire metal, or braided steel cable. The connecting arm may contain grooves or other features that permit secure engagement with the locking module 113, and prevent disengagement from the locking device 101 without the operation of an unlocking mechanism.

The locking module 113 may include an electric actuator (e.g., solenoid, motor) configured to engage and disengage a spring loaded pin housed inside an engagement point of the housing. When the actuator is in an “disengaged” or “unlocked” position the pin may be configured to release an end of the connector device (e.g., a cylindrical catch positioned at the end of a braided steel cable). When the actuator is in an “engaged” or “locked” position the pin may be configured to hold an end of the connector arm. In some embodiments, the electric actuator may be configured to be operated based on signals received from the unlocking and locking mechanisms of the locking module 113.

Upon the locking mechanism being unlocked in any manner, in some embodiments, an end portion of the connecting arm that was previously secured within or to the locking mechanism when the locking mechanism was locked can become disconnected such that it can be withdrawn from the locking mechanism, thus unlocking the locking device 101 as a whole. It is understood that both traditional and non-traditional locking functionalities are possible for the plurality of unlocking mechanisms described herein. Further, it is also understood that locking devices not utilizing connecting arms are also possible, as are other styles of connecting device.

The locking module 113 may include a plurality of unlocking mechanisms. In some embodiments, the unlocking mechanisms may each operate independently of each other. While conventional locking mechanisms may include a single unlocking mechanism, such as a combination entry system or a keyhole, embodiments of the locking system described herein include a locking mechanism that can be unlocked in a plurality of ways.

The locking module 113 may include a primary unlocking mechanism. In some embodiments, the primary unlocking mechanism may be a mechano-electrical unlocking mechanism such as a combination of button presses, or a combination lock. In some embodiments, the primary unlocking mechanism may be configured to be input by a user to unlock the locking device 101 by directly interacting with the locking device 101.

For example, the primary unlocking mechanism may include a mechanical combination, such as a series of button presses, the user may enter by depressing in a particular pattern (sequence and/or timing). One or more buttons may be pressed either together or individually. In some embodiments, the pattern for unlocking the locking device 101 may be stored in the storage device 121 of the locking device 101. The pattern may be set using the user interface 111, or by pressing the one or more buttons of the locking device 101 in the desired pattern during an initialization/setup of the locking device 101. The mechanical combination may be configured to unlock the locking device 101. Primary unlocking mechanisms may include a 3-number combination unlocking mechanism, a combination lock functionality that requires three or more, four or more, or five or more entries, with each entry being selected from, for example, numbers such as numbers from 0-9, letters such as letters of the English alphabet, other symbols, or combinations thereof. It is understood that additional numbers, letters, and other symbols are possible. In some embodiments, entry of the correct combination, sequence, and the like using the mechanical means (e.g., properly positioning values on a combination lock, properly depressing the buttons on the housing of the locking device 101) may generate and transmit an electrical signal configured to unlock the locking mechanism. The electrical signal may be received and processed by the electric actuator discussed above.

The secondary unlocking mechanism may be a standardized manner for authority figures such as the U.S. government's Transportation Security Administration (“TSA”) to open the luggage without breaking the locking device 101. One such manner is via a Travel Sentry key available to the TSA and similar organizations, which may have the need to open the lock while in transport. The secondary unlocking mechanism can thus be, for example, a key opening into which a Travel Sentry key available to the TSA and similar organizations may be inserted to unlock the locking device 101. In some embodiments, insertion of a key may generate an electrical signal for releasing the locking mechanism. In some embodiments, the key opening associated with the secondary unlocking mechanism may be isolated from the other electrical components of the locking device 101. For example, a water and dust proof barrier may be formed between the secondary unlocking mechanism's key opening and the remaining components of the locking device 101. The water and dust proof barrier may include a polycarbonate and/or rubber seal.

A tertiary unlocking mechanism may involve transmitting a signal from the user computing device 103 to the locking device 101 to unlock the locking device 101. The third unlocking mechanism may be of a digital type. For example, an unlocking code or command may be entered on the user computing device 103, communicated to the locking device 101, and used to unlock the locking device 101 using a electromechanical signal. In another example, the user interface 111 on the user computing device 103 may present the user with an icon, that when selected, may transmit a signal to the locking device 101 to unlock the locking device 101. Alternatively, or additionally, the user may enter a passcode on the user interface 111 in order to transmit a signal to the locking device 101 to unlock the locking device 101. Unlocking and/or locking may be processed by the microcontroller of the locking device 101. For example, the microcontroller may receive a SMS or Bluetooth® communication from the user computing device 103 that indicates that the locking device 101 should be unlocked. The microcontroller may then initiate a switch or moderate an actuator as described above.

The unlocking mechanisms described above may operate independently of each other. For example, the primary unlocking mechanism (e.g., manual pressing of buttons on housing) may be operated independently of the secondary (e.g., TSA-unlock) and tertiary unlocking mechanisms (e.g., mobile device unlock). Similarly, the locking device 101 can be unlocked via a Travel Sentry key without entering the proper combination or button presses to unlock the locking device 101 using its primary unlocking mechanism and without sending a code from the user computing device 103. Alternatively, in some embodiments, the locking device 101 may be configured such that it is unlockable only when the primary and tertiary unlocking mechanisms are used in unison. For example, a particular button sequence may need to be pressed just prior to or after transmitting an unlock code from the user computing device 103 to the locking device 101.

It is further understood that the locking device 101 may include other unlocking mechanisms such as keys, fingerprints, passwords, voices, face recognition, etc.

In some embodiments, the locking device 101 may include a search alert module 115. The search alert module 115 may be configured to provide a user of the locking device 101 with an indication that the locking device 101 was accessed using a Travel Sentry key or similar key to unlock the locking mechanism (i.e., secondary locking mechanism). The search alert module 115 may include a search alert indicator that is configured to alert the user of the locking device 101. The search alert indicator may be a mechanical (e.g., rotating panel) or electrical component (e.g., LED) that is positioned on the housing of the locking device 101. The search alert module 115 may also be configured to send notifications or alerts to the user interface 111.

In some embodiments, the search alert indicator is only returned to its original state or reset (indicating a lack of tampering or opening via the secondary unlocking mechanism, in this case the key opening) via the primary unlocking mechanism. In this case, the search alert indicator is reset only when the user enters an unlock code using a series of button presses or the combination locking mechanism. This configuration can prevent a person who opens the locking device 101 via the secondary unlocking mechanism, such as a TSA agent, from removing the indication that the locking device 101 had been opened by someone other than its owner, since that person will not be able to unlock the locking device 101 via the primary unlocking mechanism (i.e., series of button presses or combination). In some embodiments, the search alert indicator may be positioned along the housing of the locking device 101 at a clearly visible position. Alternatively, the search alert indicator could be placed more discretely (such as on the back or bottom of the device) or even hidden from view such that an unauthorized opener of the locking device 101 is less likely to notice it after opening the locking device 101.

The search alert indicator may be triggered mechanically, electronically or electrically (used interchangeably herein), by a mechanic-electronic combination, or in other manners. An electrical trigger may be effected, for example, by completing or breaking a circuit between the battery of the power module 117 and the search alert indicator when the locking device 101 is opened via its secondary unlocking mechanism (e.g., via the TSA Sentry Key). This electronic trigger may then change the state of the search alert indicator by, for example, powering (or removing power from) a light-based (e.g., LED), color-based, symbol-based, or other indicator. The requisite power for the operation of an electronic search alert indicator may be provided by the battery of the power module 117. In another embodiment, the search alert indicator may be triggered mechanically, for example, by utilizing the rotation of the locking mechanism of the locking module 113 when unlocked via a Travel Sentry or similar key in the key opening, such as to overcome a spring and pivot from one state to another. The mechanical trigger may result in a mechanical shift in the search alert indicator, such as a colored window shifting from green to red or a changing of a displayed symbol, or an electronic indication, such as a change in state of a light such as an LED. Combinations of these two modes (electronic and mechanical) are possible, as are other modes and combinations thereof. In one embodiment, unlocking the locking mechanism via its primary unlocking mechanism, for example by depressing the appropriate pattern of buttons for the a specific primary locking mechanism does not trigger the search alert mechanism and its search alert indicator. A triggered search alert mechanism, regardless of its mode of triggering, may also alert the owner of the locking device 101 by providing the user computing device 103 with a notification that may be displayed via the user interface 111.

In some embodiments, the locking device 101 may include a power module 117. The power module 117 may include a battery configured to provide power to the electronics of the locking device 101. The battery may include lithium-ion, lithium-ion polymer, alkaline and/or other materials, and may be rechargeable and/or replaceable. A replaceable battery may be accessed and replaced through an opening in the case or housing of the locking device 101, which may also include a cover to shield this opening. A rechargeable battery may be recharged via a recharging port, which may be, for example, a lightning port or a USB port (including but not limited to a traditional, mini-, and micro-USB). Other recharging mechanisms are also possible, including both wired and wireless recharging mechanisms, such as solar recharging. The battery may be, for example, a 650 mAh battery, or may have an electric charge between 500 and 750 mAh, or 250 to 1000 mAh, or 100 to 2000 mAh, or 2000 mAh or more, or 100 mAh or less. In some embodiments, the battery may be a 400-500 mAh removable rechargeable battery configured for at least 1000 full-use charges. Many different embodiments are possible, including embodiments with charges outside these ranges.

In some embodiments, the locking device 101 may include a tracking module 119. The tracking module 119 may interact with one or more sensors 125 and/or components of the communications module 123 to determine the current location of the locking device 101. The tracking module 119 may include a global positioning system (GPS) receiver and/or transmitter. Tracking data can also be stored within the locking device 101 for later transmission or retrieval, such as within the tracking module 119 or within a storage device 121 or a memory chip. Additionally, tracking data can be transmitted to a user via direct uplink, such as via a cord or cable, or wirelessly, such as via Bluetooth® or another type of signal (GSM, Wi-Fi®, etc.). Tracking data can include, for example, location and time/date data, though other information is also possible. In one embodiment, the data can be visually represented in an application or user interface 111 on the user computing device 103.

In some embodiments, the locking device 101 may include a storage device 121 including computer memory. The storage device 121 may be a micro-SD card, a small hard drive, or any other storage device. The storage device 121 may be inserted through a memory chip insertion slot located on the housing of the locking device 101 or it can be integrated as part of the tracking module 119 or as a component connected thereto. In addition to photographs, the storage device 121 can store recorded alerts and/or notifications produced by the locking device 101. This can eliminate the need for GSM electronics in the locking device 101 in some embodiments. Other types of storage devices, including internal, external, and remote storage devices, are possible.

In some embodiments, the storage device 121 may be configured to store instructions and/or code (i.e., firmware). The storage device 121 may also be configured to store data generated by the modules of the locking device 101. The locking device 101 may also include a microcontroller. Microcontroller may be directly programmed with instructions and code (i.e., firmware) to setup the operating parameters of the locking device. In some embodiments, the firmware may include instructions and code configured to control the system, manage the power inputs, allow for communication via Bluetooth®, Wi-Fi®, and Narrow Band Communications, and the like, setup parameters and query sensor inputs and battery levels for alerts, and communicate system status via LED indicators. The microcontroller may be further configured to receive, transmit and relay communications.

In some embodiments, the locking device 101 may include a communications module 123. The communications module 123 and/or tracking module 119 may include one or more of a global positioning system (GPS), Global System for Mobile communication unit (GSM), Wi-Fi®, Bluetooth®, Narrow Band (NB) communications, Long-Term Evolution (LTE) communications and the like. In some embodiments, the communications module 123 may be further configured to receive text messages or short message services (SMS) from a user computing device 103 and/or a server system 107 communicatively coupled to the locking device 101. SMS communications may include instructions to unlock/lock the locking device 101, and/or change parameters and settings stored in the storage device 121. In some embodiments, communication between the user computing device 103 and the locking device 101 may be enabled via a tiered communication platform in which direct communication links such as Bluetooth®, and/or NFC are prioritized over NB, GSM, Wi-Fi®, LTE, and the like. In some embodiments, the locking device 101 may be configured to communicate with the servers system 107 via SMS communications using a Bluetooth®, NB, GSM, Wi-Fi®, LTE and the like. In some embodiments, communication between the locking device 101 and the server system 107 may also be in accordance with a tiered communication structure. For example, the communication module 123 may be configured such that the locking device 101 tries to communicate with the server system 107 first via NB communication, and if NB communication is unavailable, attempts to establish a communication link using Wi-Fi®, GSM, LTE and the like. The communications module 123 may include a Bluetooth and Wi-Fi® Module and a NB communication chipset.

Furthermore, in some embodiments the communications module 123 may include at least three antennas. A first antenna may include ceramic components and be configured to be positioned in an area without metal obstruction. The first antenna including ceramic components may not be omnidirectional and may be used for the transmission and receiving of GPS related signals. A second antenna may be configured for Bluetooth® and Wi-Fi® related signals. A third antenna may be configured for NB/GSM/LTE related signals. These antennas may be configured to include metal components and be positioned within the housing of the device 101 near the exterior perimeter of the device 101. In some embodiments, the antennas may be configured in close proximity to each other and be separated by plastic and/or metal components.

NB communications may operate at low frequencies. Advantageously, in comparison to conventional systems, the described locking devices 101 including narrowband technologies may be capable of operating in areas without cell tower access, in multi-layered buildings, high and low altitudes, maritime environments, and the like. Furthermore NB communications modules may not require as much battery life as conventional methods for communication. Moreover, NB communications may be able to allow smaller data transmissions that may not be as impacted by network traffic. NB communication may work indoors, and provide a low cost, long battery life, and high connection density means for communication. NB communications may utilize a subset of LTE standards limited to a narrow-band of 200 kHz.

As discussed above, the locking device 101 can utilize various tracking technologies to establish its location and remotely communicate with the user. For example, the tracking module 119 and/or the communications module 123 may include GPS, which may allow the locking device 101 to establish its location globally. However, GPS may be difficult to use indoors, where a GPS signal may not reach. Additionally, GPS may also lack any capability of sending a signal outbound from the locking device 101.

The tracking module 119 and/or the communications module 123 may also include Wi-Fi®. Wi-Fi® may enable the locking device 101 to establish its location when a Wi-Fi® signal is present, such as via a Wi-Fi® mesh network (often even without fully logging in to the Wi-Fi® network or agreeing to any network's terms and conditions). Incoming signals can be utilized by the locking device via a Wi-Fi® mesh network by recognizing the network, without actually connecting to it. For example, a Wi-Fi® positioning system (WPS) or WiPS/WFPS can be used for establishing location in areas where GPS may not be accessible, such as indoors (or elsewhere, including where a GPS signal could be accessed). The locking device 101 may be configured to communicate data to the user utilizing Wi-Fi® if it can be fully logged in to the Wi-Fi® network or is otherwise able to use Wi-Fi® to communicate, and some devices according to the present disclosure allow the user to set whether or not the device will utilize Wi-Fi® for communication (such as by automatically agreeing to terms and conditions). Wi-Fi® communication—be it recognition of an incoming signal or usage or such a signal for outgoing communications, for example—can be accomplished utilizing any wireless telecommunications method through which information can be passed, such as the established data packet wireless telecommunication methods (e.g. 3G such as HSUPA and HSDPA 3G; 4G such as LTE, LTE Advanced, HSDPA, HSPA+, and DC-HSDPA; EDGE (Enhanced Data GSM Environment); EVDO; etc.). Wi-Fi® capability allows the device 101 to be tracked properly indoors, where luggage is often found, or outdoors, though a Wi-Fi® signal must be present in both cases. Wi-Fi® is, however, unavailable in many areas, which can in certain circumstances limit its usefulness.

The tracking module 119 and/or the communications module 123 may also include GSM, which enables both the receipt of tracking data and outgoing communication. Devices according to the present disclosure can utilize GSM to receive tracking data, such as via cell tower data and triangulation, and to send outgoing data (whether that data has been obtained via GPS, Wi-Fi®, the GSM itself, or otherwise). GSM typically requires the user to pay fees to a service provider, and its coverage is based on the coverage of the service provider.

Different combinations of the above technologies provide options to suit the user's preferences. In one embodiment, the locking device 101 may be outfitted with Wi-Fi® alone to establish location and communicate with the user. This configuration operates in any location with a Wi-Fi® signal. Two benefits of such an embodiment are its indoor functionality and lack of service charge for communication. However, as indicated above, this embodiment is limited by the requirement of a Wi-Fi® signal as well as the device's ability (or lack thereof) to utilize Wi-Fi® to communicate. In embodiments where the device cannot communicate via Wi-Fi®, the information could be stored to allow it to be retrieved later, as previously described, with a wired connection or a wireless connection such as a Bluetooth® connection. The use of only one tracking functionality may conserve power and reduces weight and volume of the locking device 101.

In another embodiment, the locking devices according to the present disclosure may be configured to use only a GPS signal. This may allow the user to conduct a post-factum analysis of the location of the locking device 101, but does not provide for real time wireless transmission of tracking data, since GPS ordinarily relies on other signals, such as Wi-Fi® or GSM, to transmit data. Thus, an embodiment that uses GPS alone could provide tracking data to the user after they have repossessed the locking device 101. Again, this configuration conserves power and reduces weight and volume compared to a device utilizing two or three functionalities.

In another embodiment, the locking devices according to the present disclosure may be configured to use only a cellular tower signal such as a GSM signal. The location of the device can be established by triangulating its GSM signal using cell towers, and outgoing data can be sent using the GSM signal. This embodiment can provide for real time transmission of tracking data, but may be limited by the user's access to cell tower data and likely requires an ongoing service charge. Again, this configuration conserves power and reduces weight and volume compared to a device utilizing two or three functionalities.

In some embodiments, the tracking module 119 and/or the communications module 123 may be configured with both GPS and GSM. GPS can be used for location tracking while GSM can be used for transmission of data, and can also be used for location tracking, such as when a GPS signal is unavailable (e.g., in many instances, indoors). This configuration typically requires a service charge for the communication, but the location service functions on a nearly global scale. Additionally, a configuration with GPS and GSM could be limited based on GPS's difficulty tracking indoors and GSM's current reliance on cell tower data for tracking, meaning tracking at an indoor location without cell coverage can be difficult.

In some embodiments, the tracking module 119 and/or the communications module 123 may be configured with both Wi-Fi® and GSM. This combination of components may permit location tracking via Wi-Fi® and communication without the navigation of Wi-Fi® terms and conditions, such as via GSM, but typically requires a service charge for the GSM functionality. The communication may be limited to areas in which the user has cell coverage or where a Wi-Fi® network is available.

In yet another embodiment, the tracking module 119 and/or the communication module 123 may be configured to utilize Wi-Fi® and GPS technologies. This combination permits location establishment outdoors, and indoors where a Wi-Fi® signal is present. The exclusion of GSM avoids a service cost and reduces power consumption, but also means that communication to the user is not possible outside of certain instances via a Wi-Fi® signal. Further, as previously described, communication via Wi-Fi® may not be possible even where a signal is present, and as such a user may have to retrieve tracking data only after retrieving the locking device 100.

Though it may result in a heavier or larger locking device 101, a locking device 101 incorporating all of GPS, Wi-Fi®, and GSM may provide additional benefits. Such a device will have excellent tracking globally outside via GPS, and can use a combination of Wi-Fi® and GSM for indoor tracking. Additionally, outgoing communications via GSM, in some instances without the complications of communication via Wi-Fi® networks, can provide a user with real-time tracking data and other information.

Furthermore, a locking device 101 having a tracking module 119 and/or communications module 123 configured for NB communications, GPS, Wi-Fi®, and GSM may provide additional benefits including improved communications and tracking globally, within enclosed areas and structures, in remote locations, and the like.

Additionally, some embodiments of the present disclosure permit the user to set what functionalities will be used. For example, for a device capable of NB, GPS, Wi-Fi®, and GSM functionalities, a user could determine that GSM is only needed in specific instances and otherwise disable GSM functionality, thus lessening the cost of GSM utilization (especially if charged on a use basis, as opposed to, e.g., a monthly basis). Similarly, disabling of one or more of the signal receiving/sending functionalities can also save battery power. For example, in some embodiments, the device may be preconfigured to first attempt communication by NB before moving to more power intensive communication methods. For instance, a user could disable GPS for a trip involving extended air travel, where luggage may only intermittently be capable of receiving a GPS signal due to being indoors or in a luggage hold. Similarly, users can choose to preset whether or not certain functionalities are used for both receipt and sending of signals (e.g., receipt of Wi-Fi® location information and sending of information via Wi-Fi®), or only one of receipt and sending (e.g., only receipt of Wi-Fi® location information, and then outgoing communications can be accomplished via GSM if that option is enabled). Many different embodiments are possible.

In some embodiments, the locking device 101 may include one or more sensors 125. Sensors 125 may include altimeters, gyroscopes, accelerometers, and the like. Sensors 125 may be used to determine if the locking device 101 is in a particular mode and to generate alerts/notifications as discussed further below. For example, if the locking device is travelling at greater than 150 mph the locking device may be on an airplane and alerts/notifications may be sent in accordance with an airplane mode. In another example, if the locking device is travelling at 1-2 miles per hour, it may be on a baggage claim, and the locking device 101 may be configured to send an alert/notification to a user device 103.

In some embodiments, the locking device 101 may include a distress module 127. The distress module 127 may include one or more buttons positioned on the exterior housing of the locking device 101. The depression of buttons in a particular preconfigured pattern may cause the locking device 101 to generate an alarm or notification. The buttons associated with the distress module 127 may be separate from or identical to the buttons used for unlocking the device. In some embodiments, the buttons associated with the distress module may be located along the housing of the locking device 101 and possibly indented into the housing such that the area surrounding the buttons is raised. Accordingly, the distress buttons may be located such that they cannot be accidently pressed. The alarm or notification may be transmitted from the locking device 101 to the user computing device 103 and/or the server system 107. The alarm or notification may also be transmitted via SMS or other communication means to one or more contacts stored in the locking device 101. These contacts may be designated by the user of the locking device 101 using the user interface 111. Additionally, the preconfigured pattern may also be designated by the user of the locking device 101.

For example, the distress module 127 may be configured such that pressing a button a certain number of times in a short period will cause the locking device 101 to send a distress signal to whomever the user has set the locking device 101 to notify. The distress signal (or alert/notification) may include information such as the time, date, and place of where the locking device 101 is. In some embodiments, the distress module 127 may be coupled to an LED light or other indicator located along the housing of the locking device. In some embodiments, the LED light or indicator may be adjusted if the user engages the distress module 127 by pressing the preconfigured pattern.

In some embodiments, the locking device 101 may include a tamper module 129. The tamper module 129 may be configured to generate an alarm or notification if the locking mechanism is tampered with. In some embodiments, the tamper module 129 may generate an alarm if a connector arm of the locking mechanism is disabled, damaged, and/or tampered with. For example, the connector arm includes coiled steel elements, if the connector arm is cut the tamper module 129 may generate an alarm or notification. In some embodiments, the tamper module 129 may be further configured to include a speaker system. In such an embodiment, the alarm may include emitting a noise via the speaker system. Additionally, in some embodiments, the tamper module 129 may include a camera configured to be positioned along the exterior housing of the locking device 101. Furthermore, the tamper module 129 may include an instruction to the camera to take an image of the area surrounding the connector arm (including potential thieves).

In some embodiments, the modules and components of the locking device 101 described above (including the locking module 113, search alert module 115, power module 117, tracking module 119, storage device 121, communications module 123, sensors 125, distress module 127, and tamper module 129) may operate in conjunction to generate one or more alerts and/or notifications. Alerts and notifications may be transmitted to the server system 107, provided to a user of the user computing device 103, emitted (i.e., light, sound) by the locking device 101, and/or displayed on (i.e., light) the locking device 101.

In some embodiments, the locking device 101 may be configured to automatically determine its location at predetermined timing intervals. In one specific embodiment, the tracking module 119 (in collaboration with the communications module 123) may produce automatic alerts/notifications at set temporal intervals. The set intervals can be configured based on the user's preference or can be predetermined at a particular interval, such as every second, five seconds, thirty seconds, minute, or other interval. These automatic location alerts/notifications aid in power conservation by preventing power-costly startup triangulation, and provide constant tracking of the locking device 101. The determined location, along with timing information may be used to generate an alert and/or notification that may be stored on the storage device 121, transmitted directly to the user computing device 103, and/or transmitted to the server system 107.

In some embodiments, the frequency at which automatic location alerts/notifications are generated may be adjusted based on the available battery power. For example, in some embodiments, the power module 117 may determine and provide an indication of the available battery power, and the frequency of the generated automatic location alerts/notifications may be modified based on the available battery power. For example, if the battery power drops below a set threshold (e.g., 15% power) location alerts/notifications may only be generated at longer intervals (e.g., on an hourly basis). For example, the timing interval may be lengthened to thirty seconds, one minute, two minutes, three minutes, five minutes, ten minutes, or even more.

In some embodiments, the frequency at which automatic location alerts/notifications are generated may be adjusted based on a mode of operation. For example, the locking device 101 may operate in an airplane mode of operation, corresponding to when the locking device 101 is detected to be on an airplane. During an airplane mode of operation, the locking device 101 may be configured to generate location alerts/notifications at longer frequencies. The locking device 101 may determine that it is in an airplane based on data and information retrieved by the tracking module 119, communications module 123, and/or sensors 125. For example, the locking device 101 travelling at a certain speed or acceleration (as detected by an accelerometer of the sensors 125, tracking module 119, and/or communication module 123) can, for instance, indicate that the locking device is on an airplane. In some embodiments, the locking device 101 may be configured to enter airplane mode if the accelerometer detects travel at or above a rate of 150 miles per hour. Additionally, the locking device reaching a certain altitude or experiencing a certain change in altitude, which can, for instance, similarly indicate that the locking device is on an airplane (as detected by an altimeter of the sensors 125, tracking module 119, and/or communication module 123). In another example, the locking device 101 may recognize that it is not receiving any signals from its included communication technologies (e.g., NB, GPS, GSM, and Wi-Fi®), which may also indicate that the locking device 101 is on an airplane. Furthermore, the locking device 101 may recognize only an airplane's Wi-Fi® signal, which can in some instances indicate that the locking device 101 is on an airplane. The device 101 could also be tethered to the user computing device 103 such that when a user pays for a Wi-Fi® signal, the device 101 has limited or full access to the Wi-Fi® signal and is thus able to communicate location alerts/notifications to the user, thus allowing the user to recognize whether or not his or her luggage is on the plane with him or her (whether or not this circumstance also reduces the automatic location alerts/notifications).

It is understood that while the above circumstances are given as examples of circumstances in which an automatic alert/notification interval may be lengthened, any number of actions can be taken when one or more of these circumstances is met, whether or not those actions include the lengthening of the automatic alert/notification interval.

Additionally, the locking device 101 may be further configured to generate alerts/notifications responsive to a request received from a user and/or an administrator of the system 100. User requests may be received by the locking device 101 in the form of a SMS from the user computing device 103.

The locking device 101 may be further configured to generate an alert/notification when the tamper module 129 determines that the locking device 101 has been tampered with. Tampering with the device may include cutting a wire embedded within the connector arm of the locking mechanism. The tamper module 129 may also determine that the locking device 101 has been tampered with if the locking device experiences a certain amount of vibration (detected, for example, by a gyroscope of sensors 125). In some embodiments, in order to recognize the connecting device 120 being broken or cut, the locking device 100 can be configured such that a circuit is broken when the connecting arm is broken or cut, sending a signal to the tamper module 129. In some embodiments, the alert/notification may be in the form of a camera flash, a flashing light, a sound, or other emission from the locking device 101. This may be in addition to or in place of an alert/notification that is transmitted from the locking device 101 to the user computing device 103 and/or the server system 107.

The locking device 101 may be further configured to generate an alert/notification when the locking module 113 unlocks the locking device 101 (for example, by the primary, secondary, and/or tertiary unlocking mechanisms discussed above). In some embodiments, the alert/notification may only be generated in the event the locking device 101 is unlocked using the primary unlocking mechanism (e.g., button presses on the housing of the device). Alternatively, the alert/notification may only be generated in the event the locking device 101 is unlocked by a user computing device 103 that is not the primary user computing device associated with the locking device 101. For example, an alert/notification may be generated when a user computing device that has restricted or temporary unlocking privileges to the locking device 101 unlocks the locking device 101. In some embodiments, the alert/notification may also be generated if the locking device 101 is opened in other manners, such as those manners described above with regard to tampering alerts/notifications (in which case that type of alert/notification may be unnecessary or duplicative; however, the sending of two simultaneous alerts/notifications may in and of itself communicate something to the user).

The locking device 101 may be further configured to generate an alert/notification when the power module 117 indicates that the battery for the locking device 101 has dropped below a threshold (e.g., 5% battery life). In some embodiments, the power module 117 may be electronically linked to the communications module 123 and/or the tracking module 119 in order to track battery power.

The locking device 101 may be further configured to generate an alert/notification configured to let the user of the user computing device 103 know that the locking device 101 arrives, or leaves from a predefined area (i.e., geo-fence). For example, the alert/notification may be produced when the locking device 101 is within a certain proximity of a target location that can be mobile or static. Example target locations include, and are not limited to, a baggage claim carousel, a home, a car, a user computing device 103, and the like.

The locking device 101 may be further configured to generate an alert/notification configured to let the user of the user computing device 103 know that a firmware update for components of the locking device 101 is available. Further, the locking device 101 may also be configured to generate an alert/notification if a subscription service associated with any of the communication and/or tracking technologies included in the locking device 101 is due to expire.

The locking device 101 may also be configured to generate and provide an alert/notification to the user of the user computing device 103 if a second user has been provided access to the locking device 101 and/or a second user unlocks or locks the locking device 101.

Any of the above described alerts/notifications may be categorized recorded at the locking device 101 (e.g., storage device 121), on the database 109 associated with the server system 107, and/or a memory component of the user computing device 103. In some embodiments, all non-automatically generated alerts/notifications (e.g., non-location alerts/notifications) may be recorded. Alternatively, some or all automatically generated alerts/notifications may also be recorded. Many different combinations of recorded/non-recorded alerts/notifications are possible and further, what alerts/notifications are recorded and what are not may change depending upon the circumstances and/or user input.

Additionally, the terms alert/notification does not imply that any outgoing communication is required (though it does occur in many instances). For example, an alert/notification generated by the tamper module 129 and/or the locking module 113 may simply be stored within the locking device 101 for later retrieval. Many different combinations are possible, and further, categories of alerts/notifications other than those described herein are possible, including categories including combinations of characteristics of different alerts/notifications described herein and/or other characteristics. Recorded alerts/notifications can be stored in a storage device that is part of the locking device 101 (such as a storage device similar to or the same as the storage device 121), and/or at another location, such as a user's device.

The components of the locking device 101 may be enclosed in a case or housing that can be made of a variety of different materials, such as metals, non-metals, plastics, composite materials, or other materials as known in the art. One example of an appropriate material is a thermoplastic and amorphous polymer, for example, ABS plastic. The case or housing can have many different dimensions. For example, some embodiments measure approximately 0.5 inch to 5 inches, or 1 inch to 3 inches, or 1.5 inches to 2.5 inches, or about 1.9 inches in length (left to right as shown); approximately 0.5 inch to 7 inches, or 1 inch to 5 inches, or 2 inches to 4 inches, or about 2.82 inches in height (top to bottom as shown); and approximately 0.1 inch to 1.5 inches, or 0.2 inch to 1 inch, or 0.4 inch to 0.8 inch, or about 0.64 inches in width (into the page as shown). The density of the polymer can be based on the calibration of the electronic components of the locking device 101. Some embodiments include a case with a density of approximately 0.1 to 5 g/cm³ or 0.5 to 2 g/cm³ or about 1 g/cm³. As will become apparent below, utilization of non-metals such as plastics, and specifically ABS plastic, can allow for other functionalities of the locking device 101, such as tracking functionalities and signal sending and receiving functionalities.

FIG. 2A-2L provide various views of an embodiment of a locking device 200 corresponding to locking device 101 of FIG. 1. The locking device 200 shown in FIGS. 2A-2L may have some or all of the same characteristics, components, and functionalities as the locking device 101 shown in FIG. 1 and described above.

In particular, FIG. 2A is a front perspective view of the locking device 200 having a top side 201 including a button 203 encircled by a LED indicator 205. In accordance with the methods and systems described above, the button 203 may be used in connection with a locking module, such as locking module 113. Additionally, in accordance with the methods and systems described above, the LED indicator 205 may be used in connection with the a locking module, such as locking module 113, a search alert module such as search alert module 115, a power module such as power module 117, a distress module such as distress module 127 and/or a tamper module such as tamper module 129. As illustrated, the locking device 200 may include a locking mechanism having a connector arm 209 having ends 207 configured to engages with one or more engagement points 213 located on the housing of the locking device 200. In some embodiments, the connector arm 209 may include one or more coiled steel wires and an electronic wire embedded within. In some embodiments, the electronic wire may form a circuit with the tamper module of the locking device 200 such that cutting the electronic wire generates an alert and/or notification. The ends 207 may include hard molded metal. In the embodiment of the locking device 200 illustrated in FIGS. 2A-2L, the housing of the locking device 200 includes at least one groove 211 configured to receive at least a portion of the connector arm 209. The groove 211 may be configured to keep the connector arm 209 near locking device 200 such that it does not interfere with the object the locking device 200 may be attached to.

FIG. 2B is a rear perspective view of the locking device 200. As illustrated, the locking device 200 may include a bottom side having a keyhole 215. As discussed above in relation to FIG. 1, the keyhole 215 may be used as a secondary locking mechanism such as a Travel Sentry key.

FIG. 2C is a top view, FIG. 2D is a bottom view, FIG. 2E is a first side view, FIG. 2F is a second side view, and FIG. 2G is a third side view of the locking device 200.

FIGS. 2H-2L provide various views of the locking device 200 in a second configuration, where the connector arm 209 is extended outwards from the locking device 200. In the illustrated views, the connector arm 209 is disengaged with the groove 211 and instead positioned at an opposite side to the groove 211. To move from the configuration depicted in FIGS. 2A-2G to the configuration of the device 200 illustrated in FIGS. 2H-2L the ends 207 of the connector arm 209 may disengage with the locking mechanism of the locking device 200 such that the connector arm 209 may move and rotate with respect to the locking device 200. The ends 207 may then be reengaged with the locking mechanism of the locking device 200.

FIG. 3 illustrates an embodiment of a locking device 300 similar to the locking device 101 and 200 illustrated in FIGS. 1, and 2A-2L. The locking device 300 shown in FIG. 3 may have some or all of the same characteristics, components, and functionalities as the locking device 100 shown in FIG. 1 and described above. The illustrated locking device includes buttons 303, and LED indicators 305 positioned along a housing of the locking device 300. As discussed above the buttons 303 and LED indicators 305 may be used in connection with one or more of the modules of the locking device 300. In the embodiment of the locking device 300 depicted in FIG. 3, a primary unlocking mechanism 319 including a combination lock is shown.

Also illustrated in FIG. 3 is a connector 309 with ends 307A, 307B. In the illustrated embodiment, a first end 307A may be fixedly connected to the housing of the locking device 300. The first end 307A may be fixedly connected to the housing of the locking device 300 in a manner that provides the connector 309 with the ability to rotate 360 degrees. A second end 307B may be configured to be releasably connected to the housing of the locking device 300 and is illustrated in FIG. 3 as being disengaged from the locking device 300. The second end 307B may be capped with a cylindrical catch that is configured to engage with an engagement point 313 of the locking mechanism of the locking device 300. When the second end 307B engages with the engagement point 313 a spring loaded pin may lock the second end 307B in place.

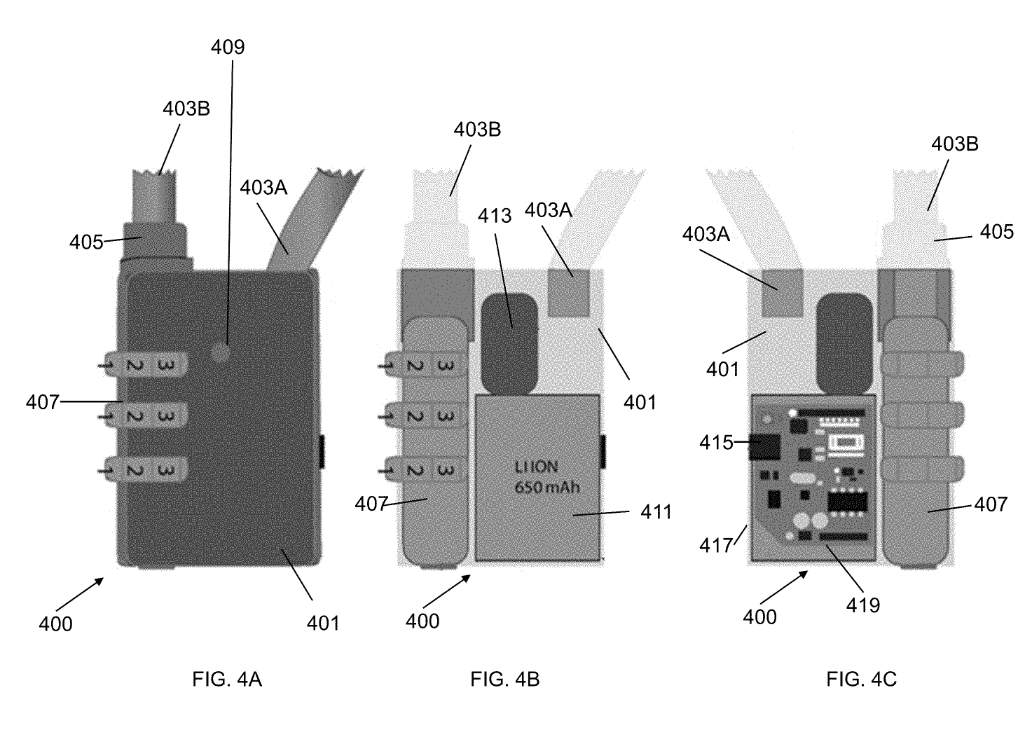

FIGS. 4A-4C illustrate an example of a locking device 400 built in accordance with the systems described herein. The locking device 400 shown in FIGS. 4A-4C may have some or all of the same characteristics, components, and functionalities as the locking device 100 shown in FIG. 1 and described above. FIG. 4A is a front elevational view of a locking device 400 according to the present disclosure including a housing or case 401. FIGS. 4B and 4C show front and rear elevational views of the locking device 400 of FIG. 4A, respectively, with the case 401 shown as transparent, such that the internal components of the locking device 400 are visible.

As illustrated in FIGS. 4A-4C, the locking device 400 may include a connecting device (i.e., connecting arm) which may be, for example, a loop or other device configured to connect the locking device 400 to, for example, a piece of luggage. In the depicted embodiment, the connecting device or connecting arm has a first end 403A fixedly attached to the housing or case 401 of the locking device 400. A second end 403B of the connecting arm is configured to releasably attach to the locking device 400 at an engagement point 405 configured to engage with a locking module 407. The illustrated locking module 407 includes an unlocking mechanism that is a combination lock. As illustrated in FIG. 4A, the housing 401 may also include a search alert indicator LED 409. The search alert indicator LED 409 may be coupled to and receive instructions from the search alert module 413. As illustrated in FIGS. 4B and 4C, the locking device 400 may also include a power module 417 including a battery 411 and one or more ports 415. As illustrated, the battery 411 may be coupled to other electrical components of the device including, for example, the tracking module and/or communications module.

The locking module 407 can in some embodiments be unlocked in three independent manners. The battery 411 may be replaceable such as via an opening in the case 401, and/or may be rechargeable such as via a recharging port 415, which could be, for example, a lightning port or a USB port (including but not limited to traditional, mini-, and micro-USB), or via solar power, or via other recharging means. The locking device 400 may also include tracking electronics 419. While referred to herein as a “recharging port 415,” the recharging port 415 and any other port described herein may also be capable of other functions, such as discharging battery power, or uploading information from the locking device 400. In other embodiments, separate ports can be utilized for different functions or combinations of functions.

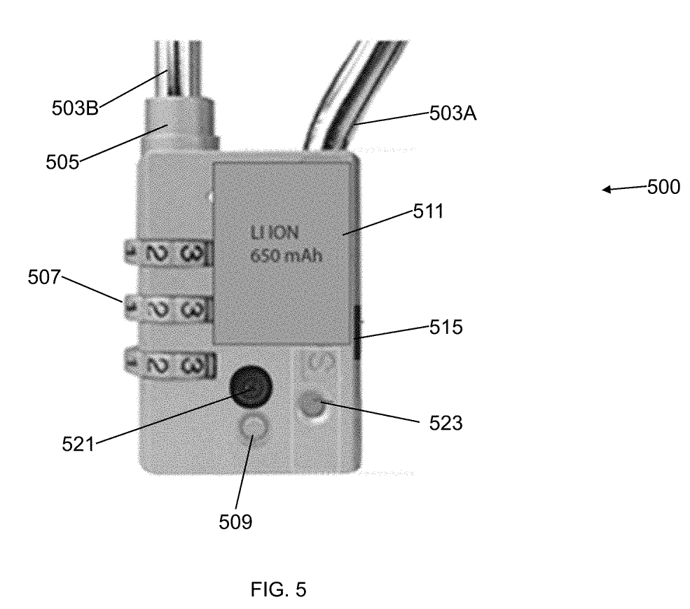

FIG. 5 illustrates another embodiment of a locking device 500. The locking device 500 shown in FIG. 5 can have some or all of the same characteristics, components, and functionalities as the locking device 101 shown in FIG. 1 and described above. In the illustrated embodiment, the locking device 500 includes a tamper module having a camera 521, and a flash bulb 523. The locking device 500 also includes a connecting device having a first end 503A fixed to the housing 501 of the locking device 500, and a second end 503B configured to engage/disengage with locking module 507. The locking device 500 also includes a power module having a battery 511 and a port 515. Many other configurations are possible.

The camera 521 can utilize varying resolutions and lenses. The camera 521 can be capable of capturing an image and converting it into data storable on the storage device (though other components could instead perform this conversion) of the locking device 500. Alternatively or additionally, this data could be directly communicated from the device 500, without having to store the data. When the locking device 500 is tampered with, opened, or upon the occurrence of one or more other circumstances, the camera 521 can be triggered to take a photograph of the tampering individual and/or the surroundings and store the photograph on the storage device of the locking device 501. Note that such triggers, or the taking of a photograph or flash itself, could also trigger an alert/notification as previously described. The camera 521 can utilize facial recognition technology to locate the face of the tampering individual prior to the taking of the photo. The camera 521 can be configured to take a photograph at the same instance the flash bulb 523 flashes and illuminates the subject of the photograph. In its stored or delivered form, the photograph may be associated with other related data, such as, for example, the time and location that the photograph was taken. The camera 521 can be triggered to photograph airport employees who unlock the locking device 500 using a secondary unlocking mechanism, such as unlocking the locking module 507 using a Travel Sentry key, thus creating airport employee accountability. The locking device 500 can also be configured to transmit the photo to the user computer device via the communication methods described above.

In one specific embodiment, the locking device 500 may be configured to provide a flash, such as from the flash bulb 523, such that the opener of the locking device 500 thinks that a photograph has been taken even if one has not. In this embodiment, the functional flash bulb 523 may be configured to flash upon a trigger similar to or the same as that of the functional camera 521 described above. This embodiment reduces the cost of the locking device 500 by eliminating components, such as the camera 521 and/or storage device. Many different combinations of components, whether functional or fake, are possible.

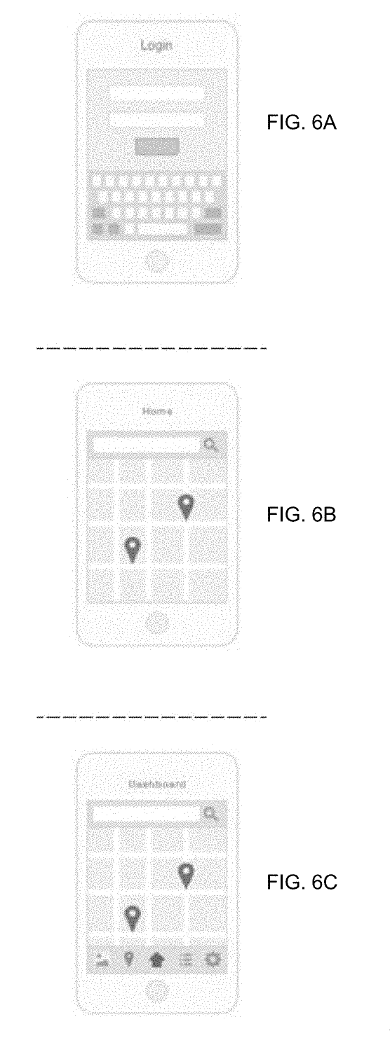

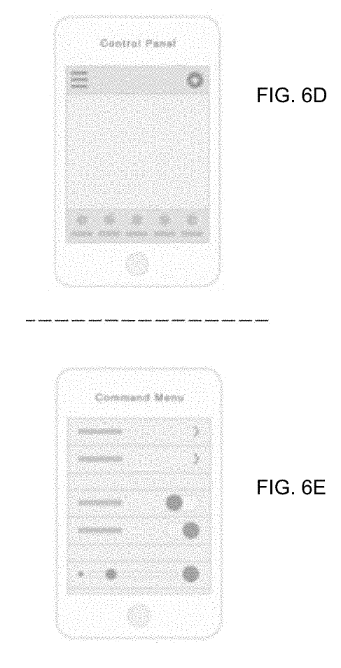

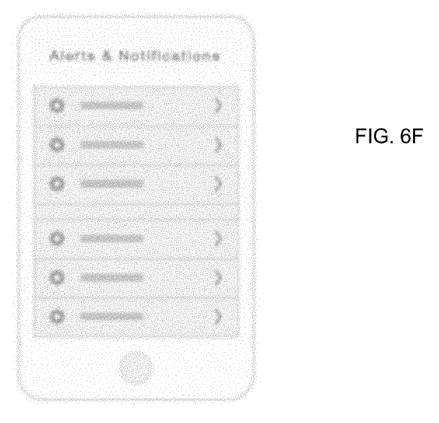

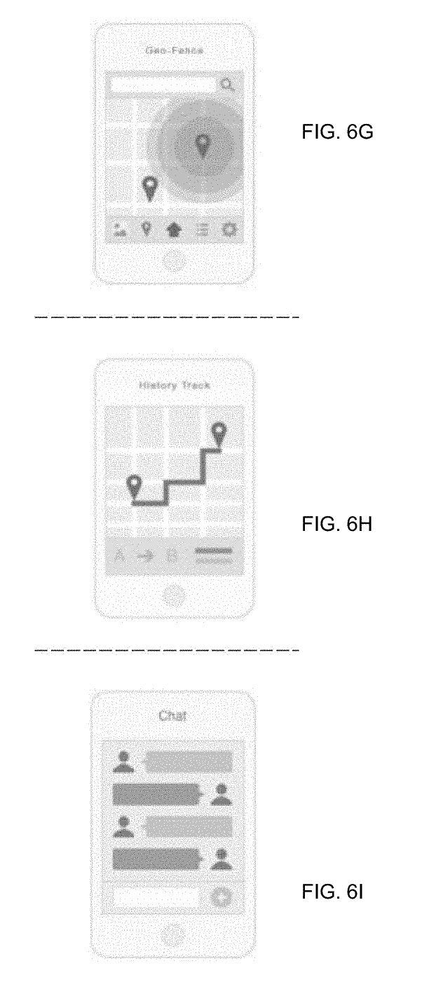

FIGS. 6A-6I illustrate various displays associated with a mobile application (i.e., user interface) configured for display on a user computing device. The mobile application illustrated in FIGS. 6A-6I can have some or all of the same characteristics, components, and functionalities as the user interface 111 shown in FIG. 1 and described above.

As discussed above, the mobile application may be communicatively coupled to a server system having an associated database (such as server system 107 and database 109). Additionally, the mobile application may also be communicatively coupled to a locking device (such as locking device 101). As will be discussed below, data and information input via the user interface may be transmitted to the server system and/or locking device and stored. The server system and/or locking device may operate in accordance with the data and information received via the user interface.

FIG. 6A illustrates a login page for a mobile application (i.e., user interface) in accordance with an embodiment of the system described above. In some embodiments, the login page may include an introduction to the application and locking system, and receive information from the user. Information received from the user may include a name, a phone number, email address, billing address, mailing address, credit/debit card payment information, a service plan indication, a pair device indication, naming preferences for devices, and import contacts from the user's mobile device. Furthermore, upon logging into the application, the user may be able to select particular contacts to whom distress signals may be sent. These contacts may correspond to the contacts that alerts/notifications are sent to by a distress module of the locking device. Furthermore, the user may be able to setup a predefined pattern for distress signals. The user may also be able to setup a code that the user can enter manually on the surface of the lock device in order to unlock the device. The code may include a pattern of button presses. Additionally, the user may also be able to setup an electronic code that may be entered on a user computing device located in proximity to the locking device in order to unlock the locking device. In some embodiments, the electronic code may be entered on a user computing device that is not pre-associated with the locking device.

FIG. 6B illustrates a startup screen for a mobile application (i.e., user interface) in accordance with an embodiment of the system described above. In some embodiments, the startup screen may include a live tracking map that displays the location of the locking device. For example, the live tracking map may display the location provided by automatically generated location alerts/notifications. The live tracking map may be configured to display information related to a plurality of locking devices 101, that may be associated with a common user computing device. For example, if a family travels together with multiple locking devices, the application may be configured such that a member of the family may view the location of all locking devices associated with the group. The startup screen may also include a button that will access controls related to the GPS devices embedded within the locking device. The startup screen may also include a refresh button, a locate button, an alert/notification countdown, a map type configuration option, an add device option, a zoom in/out preference, and menu buttons. The refresh button may be used to update data and information received from the server system and/or locking device. The locate button may be used to request location information from a locking device. The alert/notification countdown may be configured to display the time until the next time location information is expected from a locking device. A map type configuration option may adjust whether the map is displayed in satellite view or simple view. The add device button may allow for the user computing device that the mobile application is running on to be linked or associated with a particular locking device. The zoom in/out preference may adjust the display of the map. The menu buttons may include a link to the home screen, command screen, alert screen and/or information screen.

FIG. 6C illustrates a dashboard screen for a mobile application (i.e., user interface) in accordance with an embodiment of the system described above. The dashboard may display an indication of battery life, an indication of whether the locking device is moving or static, allow the user to switch between devices in real-time, and provide a description of the locking device (along with a photo). The dashboard may also display an address associated with the locking device. The dashboard may also indicate the GPS history, Wi-Fi® history, speed of movement, satellite strength, tracking information, and historical data associated with the locking device. The dashboard may also provide the user with an option to unlock or lock the locking device. The dashboard may be further configured to allow the user to elect by which mode of communication the user would like to unlock the device (e.g., Bluetooth®, Wi-Fi®, NB communication, GSM, etc.).

FIG. 6D illustrates a control panel screen for a mobile application (i.e., user interface) in accordance with an embodiment of the system described above. The control panel may include links to a command panel, an alert display, a geo-fence setting option, a device bandwidth setting mode, a date/time information panel, a share location/remote sharing panel, history panel, and/or a navigation control panel.

FIG. 6E illustrates a command panel (or command menu) for a mobile application (i.e., user interface) in accordance with an embodiment of the system described above. The command menu may be configured to allow a user to enter, edit, and/or delete one or more emergency contacts that are associated with the distress module. Contact information may include a phone number, an email address and the like. The command panel may also include settings related to a low battery/preserve mode. In some embodiments, the setting may be default set at 15% of battery level. The command menu may also include settings related to the distress module such as whether the communication to the emergency contact is sent via text, call, or both.

Further, the command menu may allow a user to configure the series of button presses that will trigger the distress module to send a communication to one or more emergency contacts. For example, in one embodiment, pressing a distress button twice and holding the distress button down for 3 seconds may override the distress module. In another example, pressing and holding a distress button for 3 seconds may alert contacts. In another example, pressing and holding a distress button 2 times in rapid succession may alert a single contact. In another example, pressing and holding a distress button 3 times in rapid succession may alert a network administrator (e.g., theme park, school, office). In another example, pressing and holding a distress button 4 times in rapid succession may alert authorities. In another example, pressing and holding a distress button 5 times in rapid succession may trigger a reserved alert. The command panel may be further configured to allow a user to enable and/or disable a distress module. The command panel may also be further configured to enable or disable one more of the communication tracking and communication technologies embedded within the locking device (e.g., Wi-Fi positioning, NB positioning, GMS positioning, Bluetooth® signaling, GPS positioning). Further, the command menu may be configured to adjust settings associated with any audible alarms emitted by the locking device.

The command menu may also allow the user to adjust parameters and settings associated with one or more of the following: Control Search Tone Length, Remote Shutdown, Proximity Detection (Set Tone/Set Vibration Pattern), Set Automatic Alert/Notification Frequency, Priority Preference Setting (NB communication, GSM, Wi-Fi®, Bluetooth®), Auto Updates for Firmware, Airplane Mode, Standby/Stop Sign Time, Speed (Kilometers Per Hour, Miles Per Hour), Measurement (Metric, Standard), and/or Auto Standby.

The command menu may also be configured to allow a user to change one or more passcodes used to the unlock the locking device. The command menu may also allow a user to share unlock access for a particular locking device with other users who have downloaded the mobile application. In some embodiments, unlock access and other permissions to a locking device may be provided by one user (i.e., a primary user) to other users (i.e., secondary users) who have downloaded the mobile application. Primary users may select the level of access provided to the secondary users. For example, a secondary user may be permitted complete access (where they may edit all user preferences), limited access (where they may edit or change select user preferences), and unlock only access (where they are only able to lock/unlock the locking device).

FIG. 6F illustrates an alert and notification menu for a mobile application (i.e., user interface) in accordance with an embodiment of the system described above. The alert and notification menu may allow a user to select whether they would prefer to receive an alert and/or notification for one or more of the following: All Alerts, Distress Alerts, Low Battery, Low Battery, Airplane Mode, Exit Geo-Fence, Enter Geo-Fence, Rapid Acceleration, Rapid Deceleration, Enter GPS Dead Zone, Exit GPS Dead Zone, Enter WIFI Zone, Exit WIFI Zone, Enter NB Zone, Exit NB Zone, Enter GSM Zone, Exit GSM Zone, Exit Bluetooth Zone, Enter Bluetooth Zone, Movement (Sudden Start/Sudden Stop), Over Speed, Power Off, Firmware Updates, Proximity Detection, Ads, Lock Closed, and Lock Opened (via the Application, TSA Key, Shared User, Broken Cable).

FIG. 6G illustrates a geo-fence for a mobile application (i.e., user interface) in accordance with an embodiment of the system described above. Geo-fence may refer to a perimeter associated with the locking device, where exiting or entering the designated perimeter may trigger the locking device to provide an alert/notification. Settings associated with the geo-fence that may be adjusted or input via the mobile application may include adding a geo-fence, editing a geo-fence, deleting a geo-fence, providing an alert when entering and/or exiting a geo-fence, enabling/disabling a geo-fence, and entering an address and/or radius for the geo-fence.

FIG. 6H illustrates a history menu for a mobile application (i.e., user interface) in accordance with an embodiment of the system described above that allows a user to view historical information about a locking device. The history menu may allow a user to search the history of a locking device by a custom date/time, or predefined periods such as by today, yesterday, last week. Furthermore, the user may be able to view the locking device's position by path taken, and/or by alerts/notifications emitted by the locking device.

FIG. 6I illustrates a Wi-Fi® hub menu for a mobile application (i.e., user interface) in accordance with an embodiment of the system described above that allows a user to view historical information about a locking device. The menu may allow the user to share information related to the locking device on a social media application, allow the user to provide access to a Wi-Fi hub provided by the locking device to a set number of users, add Wi-Fi hub user information, disclose to a user of the Wi-Fi hub that there is data size limit for communications (e.g., 1 MB maximum file size per text), and/or provide the user with access to a phone camera of the user computing device.

As described above, in some embodiments, the data produced by the tracking and/or communications electronics of the locking device can be sent to one or more additional users (e.g., a second user). Such functionality is useful, for example, when the additional user is responsible for picking up the primary user from an airport. In such a situation, the additional user can be provided access to the data produced by the locking device to remain updated as to the primary user's location. Such information allows for less time waiting at the airport for both users. It is understood that sending data to a second user or additional users is useful in other situations, for example, when luggage is stolen and the primary user provides tracking data to the police or other authorities.

In some embodiments, the user interface and server system may form a crowd-sourced sharing platform that may allow a user to find a locking device that is unable to connect with the server system and/or it's designated user computing device. For example, a non-designated user computing device that picks up a signal from the locking device may be configured to relay the locking device's information to the server system. Further the server system may then provide the designated user with information related to the locking device's position.

In some embodiments the data produced by the locking device can be visually represented in a mobile application on the user computing device (e.g., mobile device or computer), providing geographic reference points based on the locations of the user's computer or mobile device relative to the location of the locking device.

In some embodiments, a user can glean a great deal of information from the data produced by the locking device, the available information being based at least in part on what tracking technologies are present in the device. For example, configurations allowing for real-time transmission of tracking data (such as via GSM) can allow a user to tell, for example, whether their luggage is on the correct plane, the location of stolen luggage, and when luggage is ready to be claimed in baggage claim. This functionality deters theft by documenting the location of the locking device and allowing users to quickly determine when their luggage is not being handled appropriately.

In some embodiments, the disclosed device may be outfitted with a spray device in connection with the tamper module. Upon the occurrence of a particular triggering event, such as when the device is tampered with, opened, or upon the occurrence of other circumstances; or by manual operation by the user, the device can spray a solution, for example, pepper spray, mace, or other similar solutions as known in the art. Many different solutions are possible. The spray device helps deter unwanted access to the user's personal property.

In some embodiments, the locking device can be used as a power source to recharge other devices, for example, cell phones. The device may be outfitted with an incoming charging port and an outgoing charging port, or a two-way charging port, which can include, for example, lightning ports, USB ports (including but not limited to traditional, mini-, and micro-USB), or other similar ports, to permit the user to charge and discharge the battery. Some embodiments can utilize a single port for both charging the battery and discharging from the battery. Other charging methods, such as wireless charging (e.g., via solar), are also possible, as are embodiments including three or more ports and embodiments including two or more outgoing and/or incoming charging ports.

In another embodiment, the device can be configured to provide Wi-Fi® to the user (also referred to as a Wi-Fi® hub). This embodiment both provide access to the internet for the user's other devices, and eliminate the need for GSM for communication when the device was within range of a Wi-Fi® network. The Wi-Fi® hub may be used to send SMS messages from the locking device in areas where there is limited or no LTE/GSM cellular reception.

In yet another embodiment, the locking device may be configured to be wearable on the user's person, for example, as a watch or bracelet, necklace, belt buckle, or other accessory. The locking device may be part of a modular system wherein the lock can be removed quickly from the user's person and used in its function as a lock. In such a modular system, the lock mechanism may then be replaced by another accessory, for example, a watch face without a locking functionality. In another embodiment where the locking device is configured to be wearable, a strap which the user utilizes to wear the device, for example, as a watch, bracelet, or necklace, is made of a durable material, such as metal, polymers, plastics, etc., and operates as the connecting device of the device. In some embodiments a part of the wearable device, such as a watch band or bracelet body, can serve as a connecting device similar to the connective arms from FIG. 3 which can in certain instances enable the entire or almost entire wearable device (watch, bracelet, etc.) to be used as the locking device. In some embodiments, the locking device may be configured to attach to a shoelace and/or Velcro® straps such that it may be used by children, athletes, and the like. In some embodiments, the locking device may include a clip positioned along the housing that enables the locking device to be attached to a belt, belt-loop and the like. In some embodiments, the clip may position the connector device of the locking device away from a user of the locking device.

In yet another embodiment, a locking device such as the locking device 101 of FIG. 1 can include Bluetooth® or a similar communication device, such that even when the device is not receiving any GPS, Wi-Fi®, or GSM signal, the locking device could communicate with a user device so long as the two are within a certain proximity. This could be used, for example, for confirming whether or not a user's luggage has been loaded onto an airplane, where it may not be receiving any GPS, Wi-Fi®, or GSM signal.

The locking device having tracking functionality described herein may be utilized in various environments. For example, the locking device may be used in the event of a natural disaster, as narrow-band communication technology is configured to be operational even when cellular towers may be damaged. The use of narrow-band communication technology may also enable the locking device to be used in locations far away from cell reception. For example, narrow-band technology may be used in the heavily wooden or snow filled areas. The locking device may also be used in commercial and/or maritime applications (e.g., tracking a boat, scuba divers). In some embodiments, the distress module of the locking device may be used to provide alerts in stressful and/or dangerous environments (e.g., attacks, harassment, bullying). For example, if the distress button is pressed a certain number of times in a short period, the button may be used by a student to notify someone from their school (possibly the head of security) that they are getting bullied or harassed, and the alert/notification may include a time/date/place stamp of where the user is.

In some embodiments, the locking device with tracking functionality described herein may be used to track any suitable item. In particular, the locking device may include a connector device that may wrap around, engage with, clip to, hold down, or attach to an object. In some embodiments, the locking device may engage with a user in a “wearable” configuration. For example, the locking device may be clipped to a belt, or buckle, or engaged with shoelaces, and the like.

In some embodiments, the locking device with tracking functionality may be used to track a person (e.g., child, elderly individual, patient with Alzheimers), and the like. The locking device could also be used to track a pet. Tracking could be performed in crowded areas.

In some embodiments, the locking device may be attached to a vehicle or other moving object.

In some embodiments, the locking device's information may be shared amongst two or more individuals such that both a sender and a receiver can track a package in real time, or an airlines and a passenger may track luggage in real-time. In some embodiments, the tracking information may be shared with police or other authorities.

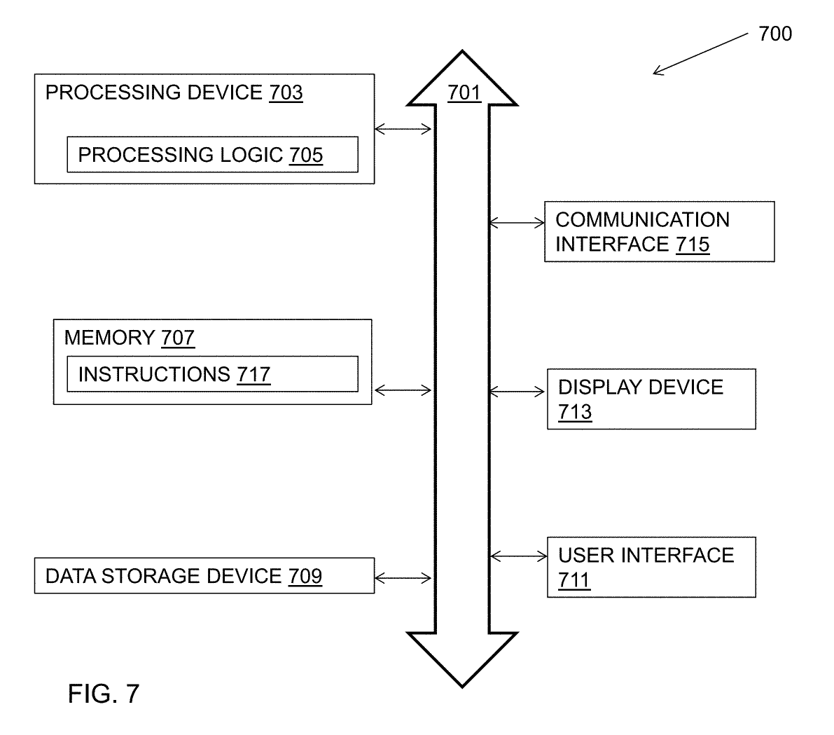

FIG. 7 is a system diagram for a computing device used in a system built in accordance with an embodiment of the present disclosure. FIG. 7 illustrates a functional block diagram of a machine in the example form of computer system 700, within which a set of instructions for causing the machine to perform any one or more of the methodologies, processes or functions discussed herein may be executed. In some examples, the machine may be connected (e.g., networked) to other machines as described above. The machine may operate in the capacity of a server or a client machine in a client-server network environment, or as a peer machine in a peer-to-peer (or distributed) network environment. The machine may be any special-purpose machine capable of executing a set of instructions (sequential or otherwise) that specify actions to be taken by that machine for performing the functions describe herein. Further, while only a single machine is illustrated, the term “machine” shall also be taken to include any collection of machines that individually or jointly execute a set (or multiple sets) of instructions to perform any one or more of the methodologies discussed herein. In some examples, the user computing device 103, locking device 101, and/or server system 107 of FIG. 1 may be implemented by the example machine shown in FIG. 7 (or a combination of two or more of such machines).

Example computer system 700 may include processing device 703, memory 707, data storage device 709 and communication interface 715, which may communicate with each other via data and control bus 701. In some examples, computer system 700 may also include display device 713 and/or user interface 711.

Processing device 703 may include, without being limited to, a microprocessor, a central processing unit, an application specific integrated circuit (ASIC), a field programmable gate array (FPGA), a digital signal processor (DSP) and/or a network processor. Processing device 703 may be configured to execute processing logic 705 for performing the operations described herein. In general, processing device 703 may include any suitable special-purpose processing device specially programmed with processing logic 705 to perform the operations described herein.

Memory 707 may include, for example, without being limited to, at least one of a read-only memory (ROM), a random access memory (RAM), a flash memory, a dynamic RAM (DRAM) and a static RAM (SRAM), storing computer-readable instructions 717 executable by processing device 703. In general, memory 707 may include any suitable non-transitory computer readable storage medium storing computer-readable instructions 717 executable by processing device 703 for performing the operations described herein. Although one memory device 707 is illustrated in FIG. 7, in some examples, computer system 700 may include two or more memory devices (e.g., dynamic memory and static memory).

Computer system 700 may include communication interface device 711, for direct communication with other computers (including wired and/or wireless communication), and/or for communication with network 105 (see FIG. 1). In some examples, computer system 700 may include display device 713 (e.g., a liquid crystal display (LCD), a touch sensitive display, etc.). In some examples, computer system 700 may include user interface 411 (e.g., an alphanumeric input device, a cursor control device, etc.).

In some examples, computer system 700 may include data storage device 709 storing instructions (e.g., software) for performing any one or more of the functions described herein. Data storage device 709 may include any suitable non-transitory computer-readable storage medium, including, without being limited to, solid-state memories, optical media and magnetic media.

Although the present disclosure has been described in detail with reference to certain preferred configurations thereof, other versions are possible. The actual scope of the disclosure encompasses not only the disclosed embodiments, but also all equivalent ways of practicing or implementing the disclosure. The above detailed description of the embodiments of the disclosure is not intended to be exhaustive or to limit the disclosure to the precise form disclosed above or to the particular field of usage mentioned in this disclosure. While specific embodiments of, and examples for, the disclosure are described above for illustrative purposes, various equivalent modifications are possible within the scope of the disclosure, as those skilled in the relevant art will recognize. The elements and acts of the various embodiments described above may be combined to provide further embodiments. Further, the teachings of the disclosure provided herein may be applied to products and systems other than locks.

We claim:

1. A locking device comprising:
a connector arm configured to engage with and secure an object to the locking device; and
a housing comprising:
a locking module comprising a locking mechanism configured to releasably secure and engage the connector arm with the housing, and a plurality of unlocking mechanisms configured to release and disengage the connector arm from the housing;
a communications module configured to receive and transmit signals for operating one or more of the locking module, a tracking module, a search alert module, a distress module, and a tamper module,
the tracking module configured to determine the location of the locking device based on one or more signals transmitted and received from the communications module;
the search alert module configured to provide a search alert notification to a user of the locking device responsive to the use of at least one of the plurality of unlocking mechanisms of the locking module;
the distress module configured to provide a distress notification to a designated contact of the user of the locking device via the communications module; and
the tamper module configured to determine whether at least one of the connector arm and the housing was accessed without engaging one of the plurality of unlocking mechanisms of the locking module and provide, via the communications module, a tamper notification to the user of the locking device responsive to determining that at least one of the connector arm and the housing was accessed without engaging one of the plurality of unlocking mechanisms.

2. The locking device of claim 1, wherein a primary unlocking mechanism from among the plurality of unlocking mechanisms is configured to receive electromechanical input from the user of the locking device by input at the housing of the locking device.

3. The locking device of claim 2, wherein the electromechanical input comprises performance of a predetermined unlocking sequence on one or more buttons located on an exterior of the housing that are operable for releasing and disengaging the connector arm from the housing.

4. The locking device of claim 1, wherein a secondary unlocking mechanism from among the plurality of unlocking mechanisms is configured to receive a standardized mechanical key.

5. The locking device of claim 4, wherein use of the secondary unlocking mechanism initiates the search alert module to provide a notification to the user of the locking device.

6. The locking device of claim 1, wherein a tertiary unlocking mechanism from among the plurality of unlocking mechanisms includes a wireless signal configured for releasing and disengaging the connector arm from the housing.

7. The locking device of claim 1, wherein the communications module is configured for operation using at least one of a Bluetooth®, Narrowband, GSM, LTE, Wi-Fi®, and Near Field communication protocols.

8. The locking device of claim 7, wherein communication module is configured to prioritize communication using Bluetooth® and Near Field communication protocols over at least one of the Narrowband, GSM, LTE, and Wi-Fi® communication protocols.

9. The locking device of claim 8, wherein the communication module is configured to prioritize communication using Narrowband communication protocols over at least one of GSM, LTE, and Wi-Fi® communication protocols.

10. The locking device of claim 1, wherein the housing comprises at least one of a gyroscope, accelerometer, and altimeter.

11. The locking device of claim 1, wherein the distress notification is generated responsive to performance of a predetermined sequence on one or more distress buttons located on an exterior of the housing.

12. The locking device of claim 1, wherein the housing comprises a non-transitory memory configured to store data produced by at least one of the locking module, the search alert module, the tracking module, the communications module, the distress module, and the tamper module.

13. A system comprising:
a locking device comprising:
a locking module having a locking mechanism configured to releasably engage with and secure the locking device to an object, and a plurality of unlocking mechanisms configured to release and disengage the object from the locking device;
a communications module configured to receive and transmit signals for operating one or more of the locking module, a tracking module, a search alert module, a distress module, and a tamper module,
the tracking module configured to determine the location of the locking device based on one or more signals transmitted and received from the communications module;
the search alert module configured to provide a search alert notification to a user of the locking device responsive to the use of at least one of the plurality of unlocking mechanisms of the locking module;
the distress module configured to provide a distress notification to a designated contact of the user of the locking device via the communications module; and
the tamper module configured to determine whether the locking device was accessed without engaging one of the plurality of unlocking mechanisms of the locking module and provide, via the communications module, a tamper notification to the user of the locking device responsive to determining that the locking device was accessed without engaging one of the plurality of unlocking mechanisms;
a user computing device communicatively coupled to the locking device and a server system, the user computing device comprising a user interface configured to display data and information related to the locking device received from the locking device and the server system; and
the server system configured to generate one or more graphics configured for display on the user interface based on operation of the locking device,
wherein operation of the locking device is based on user preferences and settings provided by at least one of the server system and the user computing device via the user interface.

14. The system of claim 13, wherein the user interface displays tracking data provided by the tracking module of the locking device.

15. The system of claim 13, wherein the user interface displays at least one of the distress notification and a search alert notification.

16. The system of claim 13, wherein the tamper module is configured to generate a tamper notification when it determines that there was unauthorized access to the locking device and the tamper notification is communicated to the user interface for display.

17. The system of claim 13, wherein
a primary unlocking mechanism from among the plurality of unlocking mechanisms is configured to receive electromechanical input from a user of the locking device by input at a housing of the locking device,
a secondary unlocking mechanism from among the plurality of unlocking mechanisms is configured to receive a standardized mechanical key, and
a tertiary unlocking mechanism from among the plurality of unlocking mechanisms includes a wireless signal configured for releasing and disengaging the object from the locking device.

18. The system of claim 13, wherein the communications module further comprises a tiered protocol where the communications module is configured for operation using at least one of a Bluetooth®, Narrowband, GSM, LTE, Wi-Fi®, and Near Field communication protocols, configured to prioritize communication using Bluetooth® and Near Field communication protocols over at least one of the Narrowband, GSM, LTE, and Wi-Fi® communication protocol, and further configured to prioritize communication using Narrowband communication protocols over at least one of GSM, LTE, and Wi-Fi® communication protocols.

19. The system of claim 13, wherein the server system is communicatively coupled to a database configured to store at least one of firmware, user preferences, and locking device information, wherein locking device information further comprises an association between user computing devices and locking devices.

20. The system of claim 13, wherein the designated contact of the user of the locking device is provided by the user to the locking device via the user interface.
